(19) United States
(12) Patent Application Publication
(10) Pub. No.: US 2012/0012348 A1
(43) Pub. Date: Jan. 19, 2012

(54) FIRE EXTINGUISHER SYSTEM FOR WHEEL WELL

(75) Inventors: Thomas D. Gracik, Glen Burnie, MD (US); Albert G. Holder, Baltimore, MD (US)

(73) Assignee: The United States of America, as represented by the Secretary of the Navy, Arlington, VA (US)

(21) Appl. No.: 12/835,767

(22) Filed: Jul. 14, 2010

(51) Int. Cl. A62C 3/07; A62C 13/62

(52) U.S. Cl. 169/62; 169/71

(57) ABSTRACT

A fire extinguisher comprises an elongated tube. The elongated tube has a pressure-tight, thermoplastic exterior tubular wall and an axially parallel, flame resistant inner wall. The inner tubular wall defines a chamber and the wall has ports through the wall at regular intervals along the length and around the circumference providing fluid communication between the chamber and the exterior tubular wall for a quantity of fire extinguishing fluid under pressure in the chamber. The thermoplastic exterior wall ruptures on contact with flame. The inner tubular wall remains intact and fire extinguishing agent discharges through the ports to extinguish the fire. The apparatus is actuated by contact with flame and requires no actuation by the vehicle crew.

### STATEMENT OF GOVERNMENT INTEREST

The invention described herein may be manufactured and used by or for the Government of the United States of America for governmental purposes without the payment of any royalties thereon or therefor.

### BACKGROUND OF THE INVENTION

1. Field of the Invention

The device relates to a fire extinguisher and particularly to a fire extinguisher system for vehicles.

2. Discussion of the Related Art

Motor vehicles equipped with synthetic rubber tires are subject to the risk of tire fires. These tire fires are ignited by extreme heat as a result of travel and road conditions and by fuel related leaks. Law enforcement vehicles are exposed to the risk of tire fire during riots or other civil disturbances and by vandalism. Law enforcement vehicles often come equipped with general purpose hand held fire extinguishers which are useful for putting out tire fires.

Military vehicles and other armored vehicles are subject to these same risks with the addition of ignition by fire bombs and other explosive devices. Unfortunately it may not be possible for personnel to leave a military or armored vehicle to extinguish a tire fire. The tire fire may have been caused in part to lure crew members out of the vehicle. Also, the chaos of the moment may leave a tire fire undetected by the crew for enough time to allow the fire to spread in the vehicle to the engine compartment and fuel tank and to produce toxic smoke. The result can be catastrophic damage to the vehicle and harm to the crew.

There is a need in the art for a fire extinguisher and fire extinguisher system particularly adapted for tire fires on military, police and armored vehicles.

### SUMMARY OF THE INVENTION

A fire extinguisher comprises an elongated tube. The elongated tube has a pressure-tight exterior tubular wall and an axially parallel inner wall contained therein. The inner tubular wall defines a chamber and the wall has ports through the wall at regular intervals along the length and around the circumference providing fluid communication between the chamber and the exterior tubular wall for a quantity of fire extinguishing fluid under pressure in the chamber.

Material of construction for the exterior tubular wall is thermoplastic material. Material of construction for the inner tubular wall is fire-resistant material. The exterior tubular wall ruptures on contact with fire. The inner tubular wall remains intact and functional. Fire extinguishing fluid passes through the ports under pressure to the area of rupture in the exterior tubular wall to extinguish the fire. This occurs without detection or action by the vehicle crew.

### BRIEF DESCRIPTION OF THE DRAWINGS

A more complete appreciation of the invention and many of its attendant advantages will be readily appreciated as the same becomes better understood by reference to the following detailed description when considered in connection with the accompanying drawing wherein:

FIG. 1 is a perspective side elevated view of a military vehicle with an elongated tube fire extinguisher adjacent wheel wells.

FIG. 2 is a cross-sectional side view of an elongated tube fire extinguisher. FIG. 2A is a sectional side view of a fire exchanger taken along line 2a-2a in FIG. 2.

FIG. 3 is a cross-sectional side view of another elongated tube fire extinguisher. FIG. 3A is a sectional side view of the fire extinguisher taken along line 3a-3a in FIG. 3.

FIG. 4 is a side view of an inner tubular wall. FIG. 4A is a sectional view of the inner tubular wall taken along line 4a-4a in FIG. 4.

FIG. 5 is a side view of an alternate inner tubular wall. FIG. 5A is a sectional view of the inner tubular wall taken along line 5a-5a in FIG. 5.

FIG. 6 is a side view of another alternate inner tubular wall. FIG. 6A is a sectional view of the inner tubular wall taken along line 6a-6a in FIG. 6.

FIG. 7 is a schematic view of a fire extinguisher system.

### DETAILED DESCRIPTION OF THE INVENTION

The invention is described with reference to the drawing wherein numerals in the written description correspond to like-numbered elements in the several figures. The drawing discloses a preferred embodiment of the invention and is not intended to limit the generally broad scope of the invention as set forth in the claims.

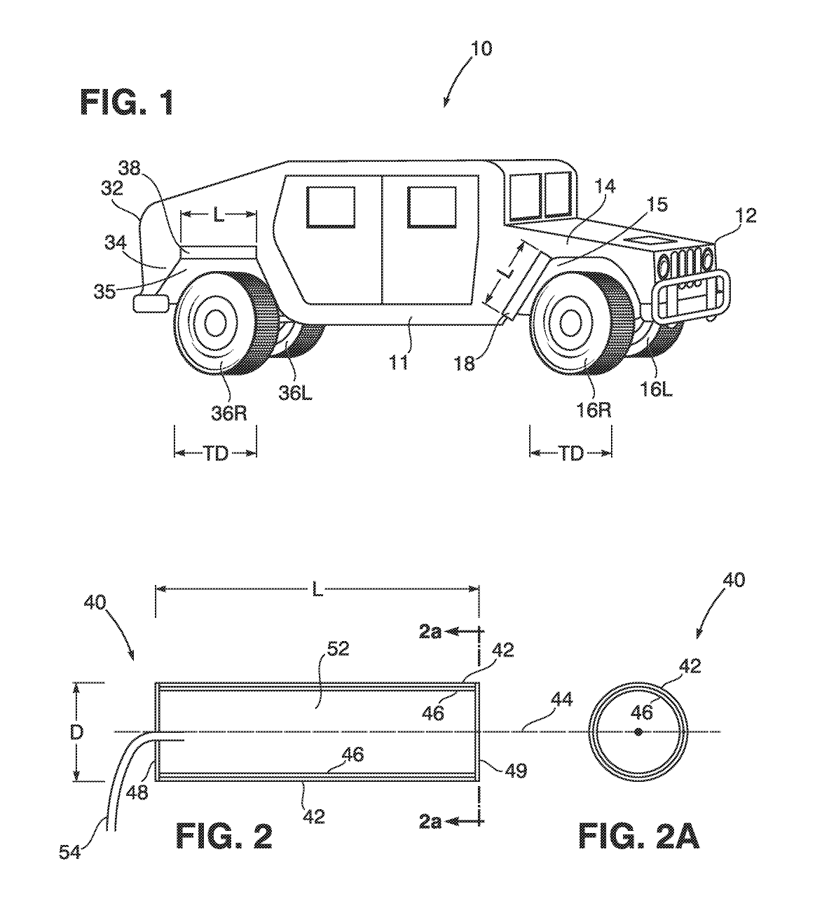

Reference is made to FIG. 1 which shows a military vehicle 10 having a body 11 with a front end 12 and a rear end 32. The front end 12 of body 11 is further defined by a right front fender 14 covering a space known as a right front wheel well 15. Right front tire 16R, having a diameter TD, is mounted in right front wheel well 15. A portion of left front tire 16L is also shown in the drawing. Left front tire 16L is mounted in a corresponding wheel well (not shown) on the left side of the vehicle 10. A fire extinguisher 18, having length L, is mounted on right front fender 14, aft and substantially in view of right front tire 16R. This fender mounting was chosen to show a retrofitting of the fire extinguisher on an existing vehicle with no additional useable space in the wheel well to accommodate a fire extinguisher. In the alternative, a fender can be modified in an original installation or after the fact to provide additional volume in the wheel well space to accommodate the fire extinguisher. The mounting of the fire extinguisher may affect the choice in the pattern of ports in the fire exchanger as will be discussed. Also, it is apparent that a fire extinguisher (not shown) is mounted in view of left front tire 16L.

The rear end 32 of body 11 is further defined by a right rear fender 34 covering a space known as a right rear wheel well 35. A right rear tire 36R, having a diameter TD, is mounted in right rear wheel well 35. A portion of left rear tire 36L is also shown in the drawing. Left rear tire 36L is mounted in a corresponding wheel well (not shown) on the left side of vehicle 10. A fire extinguisher 38, having a length L, is mounted on right rear fender 34 above and in substantial view of right rear tire 36R. Again, this fender mounting was chosen to show a retrofit of the fire extinguisher with minimal modification of the fender. A new installation can be accomplished with a fender modified to include the fire extinguisher in the wheel well. Also, a fire extinguisher (not shown) is mounted in substantial view of left rear tire 36L.

Reference is made to FIG. 2 showing a cross-sectional side view of a fire extinguisher 40 having an outside length of L and an outside diameter of D. Length L and diameter D are selected in view of the dimensions of the space for installation, i.e. the wheel well or the permissible width of the vehicle, and also in view of the tire of diameter TD that it is to protect. In FIG. 1 it is seen that the length L of the fire extinguisher 38 is generally equal to the diameter TD of tire 36R in order to provide full coverage of the tire with fire extinguishing agent. A fire exchanger length L greater than the tire diameter TD is not necessary. A fire exchanger length L significantly less than the tire diameter TD provides less range and could be less effective depending on the extent of the fire. The L/D ratio is not critical and is in general a parameter selected to accommodate the space available. L/D ratio can range from 0.25 to 2, preferably 0.5 to 1, but is not limited to this range.

An exterior tubular wall 42 is cylindrical in shape as defined by axis 44. A co-axial inner tubular wall 46 is in direct contact with exterior tubular wall 42. A pair of end caps 48 and 49 seal the ends of both the exterior tubular wall 42 and inner tubular wall 46. This produces chamber 52 contained within inner tubular wall 46. The sealing of the exterior tubular wall 42 is such that it is pressure-tight when chamber 52 is supplied with fire extinguishing gas via supply pressure tube 54 at usual above-atmospheric fire extinguisher pressures. Pressure testing of the fire extinguisher with test gas, e.g. air or nitrogen, shows no leakage at usual fire extinguisher pressures. That is, it is air-tight or better. Details of inner tubular wall 46 are not seen in FIG. 2A because the cross-section taken does not intersect a port.

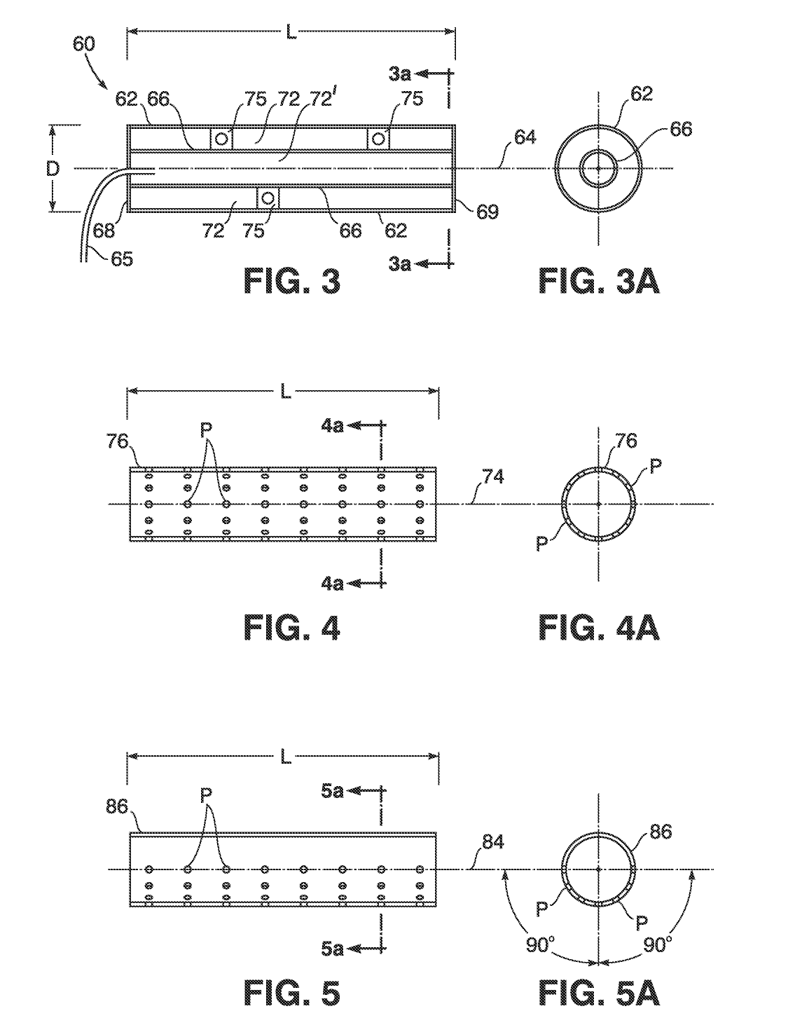

Reference is made to FIG. 3 showing a cross-sectional side view of a fire extinguisher 60 having outside dimensions, i.e. length L and diameter D, similar to those of fire extinguisher 40 in FIG. 2. An exterior tubular wall 62 is cylindrical in shape as defined by axis 64. A co-axial inner tubular wall 66 is spaced from exterior tubular wall 62 to produce inner chamber 72 and a second chamber 72′ between the two walls. Optionally, supports 75 can be inserted between the two walls to support the outer exterior tubular wall 62 and prevent possible flexing or vibration. In the drawing, supports 75 are shown with a hole to indicate that the supports 75 do not impede gas flow. A pair of end caps 68 and 69 seal the ends of the exterior tubular wall 62 and inner tubular wall 66 forming a first chamber 62 within inner tubular wall 66. The sealing of the exterior tubular wall 62 is such that the fire extinguisher 60 is pressure-tight when supplied with fire extinguishing gas via supply pressure tube 65 at usual fire extinguisher pressures. That is, the exterior tubular wall is pressure tight. Details of inner tubular wall 66 are not seen in FIG. 3A because the cross-section taken does not intersect a port.

### Materials of Construction

The inner tubular wall, end caps and pressure tubes are made of flame resistant material. For example, the inner tubular wall and end caps can be made of aluminum, aluminum alloy, steel such as stainless steel or a copper alloy such as brass. Ceramics are also useful for this purpose. Flame resistant plastic is also known for making fire extinguisher components. These plastics are typically bromine containing polymers of which decabromodiphenyl ether (decaBDE) is in use. Other flame resistant plastics are known but are not commercially available at the present time.

The outer tubular wall is light weight, flexible and resistant to the above atmospheric pressures at ambient temperatures, i.e. around 30° C. and below. Thermoplastic materials include polyacetal, polyethylene terephthalate, and polyamid.

Polyamid includes nylon 6, nylon 6,6, nylon 12 and nylon 12,12. For example an outer tubular wall of nylon 12 or nylon 12,12 can be made with a wall thickness of 1.0 to 4.0 millimeters. An outer tubular wall will hold pressure at ordinary vehicle environment operating temperatures. At fire and flame temperatures of 100° C. and greater, the material will soften and rupture under above-atmospheric fire extinguisher pressures. It is reported that a 1.0 millimeter nylon 12,12 wall will hold a pressure of 80 psi and will rupture when exposed to an open flame at temperature 100° C.

The outer tubular wall 62 shown in FIG. 3 is typically thicker than the outer tubular wall 42 shown in FIG. 2. In FIG. 3, the wall is supported by the three dimensional integrity of the cylinder and end caps, but not laterally as it is in FIG. 2. The thickness must impart an increment of structural integrity at temperatures below about 100° C. while retaining the essential property of melting and thereby rupturing at the point of flame contact, that is, at flame temperatures of about 100° C. and above. For these purposes, a wall thickness of 0.2 to 10 millimeters is recommended. The selection will be made depending on the pressure of the fire extinguishing agent that is contained. These pressures may be from 1.2 to 10 atmospheres, typically 2 to 5 atmospheres. Supports 75 support the outer tubular wall. Supports 75 also function to dampen vibration. Of course, the thickness can be increased if use in the field indicates that more vibration sustainability and abrasion resistance is required.

### Mechanism

The mechanism of the invention relies on the structural combination of the inner tubular wall and outer tubular wall, the pattern of ports in the inner tubular wall and the materials of construction of each. At temperatures below flame temperatures, the fire extinguisher, and in particular the outer tubular wall, holds the pressure of the contained flame extinguishing agent. On exposure to a flame, the outer tubular wall ruptures at the point of contact. The inner tubular wall does not rupture but retains its integrity and function to discharge fire extinguishing agent through ports traversing the wall. Discharge is only through ports that are exposed in the area of the ruptured outer tubular wall.

This arrangement relies on the flame resistance of the inner tubular wall. The inner tubular wall retains its integrity and functions effectively during a fire. The ports are functional nozzles that remain in place adjacent the fire, discharging flame extinguishing agent at the point of flame contact. The pattern of nozzles on the inner tubular wall is critical. The pattern is chosen for the desired flame threat coverage. A pattern is chosen so that ports do not discharge fire extinguishing agent in a direction where no flame threat exists or in a direction that is not to be covered by fire extinguishing agent. This could potentially occur after rupture should melting of the exterior tubular wall continue and additional inner tubular wall be exposed. Limiting the pattern of ports to the potential flame threat limits the discharge of flame extinguishing agent. As a result, flame extinguishing agent is not wasted, and the quantity of flame extinguishing agent is more effectively used. The pattern of the ports can be critical to successfully extinguishing a fire when a limited supply of flame extinguishing agent is available. A vehicle in the field is limited to the supply of flame extinguishing agent in the reservoir. As explained in the description of the fire extinguishing system, the supply can be extended somewhat.

Reference is made to FIGS. 4, 5 and 6 which show details of the inner tubular wall. In FIG. 4 is an inner tubular wall 76. Tubular wall 76 is cylindrical in shape as defined by axis 74. Through the inner tubular wall 76 is a multiplicity of discharge ports P spaced at regular intervals along the length L of the wall. It is also seen in FIG. 4A that the ports are spaced at regular intervals around the entire circumference of the cylindrical wall. This arrangement of ports around the entire circumference would be used for a fire extinguisher contained within a wheel well. All of the fire extinguishing agent discharged from exposed ports would be effectively used. All fire extinguishing agent can potentially discharge directly on flames or by ricochet off of a fender.

In FIG. 5 is an inner tubular wall 86. Tubular wall 86 is cylindrical in shape as defined by axis 84. Through the inner tubular wall 86 is a multiplicity of discharge ports P spaced at regular intervals along the length of the wall. It is also seen in FIG. 5A that the ports are spaced at regular intervals around one-half circumference, i.e. 180°, of the cylindrical wall. This arrangement of ports around one-half circumference would be used for two applications. In one application, the fire extinguisher is fastened to a horizontal or vertical wall within a wheel well. It would serve no purpose to have ports on the fastened side of the fire extinguisher. In this case, the fire extinguisher has directional discharge and distinctive indication of discharge direction is indicated on the exterior tubular wall (not shown).

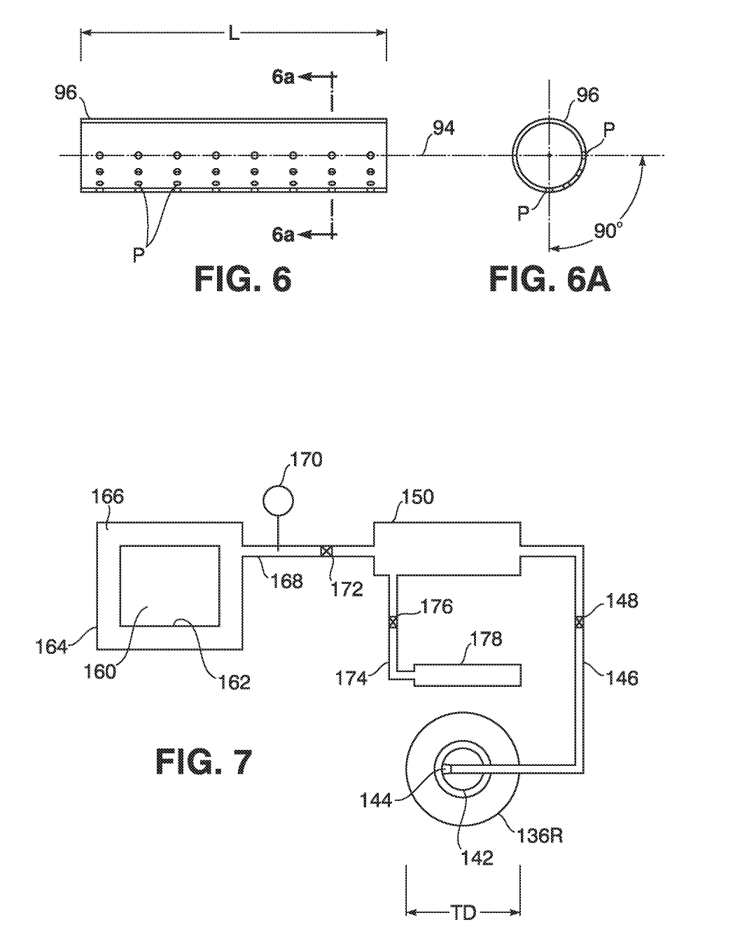

In FIG. 6 is an inner tubular wall 96. Tubular wall 96 is cylindrical in shape as defined by axis 94. Through the inner tubular wall 96 is a multiplicity of ports P spaced at regular intervals along the length of the wall. It is also seen in FIG. 6A that the ports are spaced at regular intervals around one-quarter circumference, i.e. 90°, of the cylindrical wall. This arrangement of ports around one-quarter circumference would be used for two applications. In one application, the fire extinguisher is fastened vertically in a wheel well, forward or aft of the tire. All of the spray would impact the rotating tire. The other application is shown in FIG. 1 where the fire extinguisher is at least partially outside the wheel well and a relative narrower angle of spray is desired so that fire extinguishing agent is sprayed only into the wheel well toward the tire.

In a preferred embodiment, the inner tubular wall has ports at regular intervals along its length and at regular intervals around on-quarter, 90°, to one-half, 180°, of its circumference. In this embodiment, the fire extinguisher has directional discharge and indicia of discharge direction are indicated on the exterior tubular wall (not shown). Indicia of discharge direction are used for initial mounting of the fire extinguisher on the vehicle and are also useful during periodic safety checks of the fire extinguisher and fire extinguisher system.

### Fire Extinguisher System

Attention is drawn to FIG. 7 in combination with FIG. 1 which illustrates a fire extinguisher system carried in a vehicle such as military vehicle 10 in FIG. 1. Also, the right rear tire 136R and the fire extinguisher 178 in FIG. 7 correspond respectively with the right rear tire 36R and fire extinguisher 38 in FIG. 1. Fuel tank 160 is mounted in vehicle 10 toward the rear end 32 above the axel (not shown) between the wheel wells for tire 36R and 36L.

Tire 136R is mounted on wheel 142 which has a rotating union 144 providing access and fluid communication between inflation gas in tire 136R and gas pressure tube 146. Gas pressure tube 146 is in fluid communication with gas reservoir 150 by way of shut-off valve 148.

Fuel tank 160 is defined by tank wall 162. A jacket is defined by jacket wall 164 surrounding tank wall 162. Between tank wall 162 and jacket wall 164 is a space 166 filled with gas from reservoir 150 by way of gas pressure tube 168, hydrocarbon detector 170 and shut-off valve 172.

Fire extinguisher 178 is adjacent tire 136R. Gas pressure tube 174 is in fluid communication with fire extinguisher 178 by way of shut-off valve 176.

Reservoir 150 in this example is a carbon dioxide cylinder. Reservoir 150 supplies fire extinguishing gas to fire extinguisher 178. If reservoir 150 becomes depleted in gas, it can draw on gas from tire 136R and from space 166, i.e. the fuel tank jacket.

The reservoir contains a quantity of fire extinguishing agent. In the fire extinguishing system wherein the fire extinguishing agent is used to jacket the fuel tank and to inflate the tires, the fire extinguishing agent is a gaseous fire extinguishing agent. Carbon dioxide is preferred. Other fire extinguishing agent gases are known such as perfluorocarbon, hydrochlorofluorocarbon or hydrofluorocarbon gas. Vehicle exhaust gas can also be used, particularly exhaust gas scrubbed to remove combustible hydrocarbons.

The reservoir is filled to capacity with a fluid fire extinguishing composition under above atmospheric pressures. That is, pressures of from 1.2 to 10 atmospheres, particularly 2 to 5 atmospheres.

In another embodiment where the fire extinguishing agent is used only to extinguish a tire fire, the fire extinguishing agent can be a gaseous fire extinguishing agent or the fire extinguishing agent can be water or water enhanced with another flame extinguishing agent such as high expansion foam. High expansion foam is effective and uses less water.

By way of example, in a water extinguishing agent system the reservoir/delivery system pressure is 30 psi. Discharge ports P are 1/16 inch diameter with 1 inch spacing. Water delivery rate per discharge port P is approximately 0.5 gallons per minute. This example provides good results for both a stationary and a moving vehicle.

By way of example, in a gas extinguishing agent system such as carbon dioxide, the discharge port P diameter would be smaller than for the water based system. A discharge port P diameter is about 1/64-inch diameter. Military tire pressure is about 50 psi. Therefore the fire extinguisher system pressure for the gas based system would be about 50 psi. The delivery rate of carbon dioxide is about 10 liters per minute. Since gas based extinguishing systems rapidly dissipate, the discharge port P spacing is about ½-inch.

A dual fire extinguishing agent system delivers both water based high expansion foam and carbon dioxide. For either the water or gas extinguishing agent system, the inner tubular wall diameter is ⅜-inch and the outer tubular wall diameter is ¾-inch.

The fire extinguisher and fire extinguisher system of the invention work without vehicle crew intervention. Of course, instrumentation can installed adding to information available to the crew. Instrumentation for reservoir level and pressure can be installed with indicators and alarms added to an instrument panel for use by the crew. Explosion and fire sensors can be installed in the wheel wells and tire pressure can be measured and sent to the instrument panel. A control system can be added so that valve 172 shuts on a signal of hydrocarbon contamination in line 168 by analyzer 170.

The foregoing discussion discloses and describes embodiments of the invention by way of example. One skilled in the art will readily recognize from this discussion, that various changes, modifications and variations can be made therein without departing from the spirit and scope of the invention as defined in the following claims.

What is claimed is:

1. A fire extinguisher comprising:
an elongated tube having:
(i.) a pressure-tight exterior tubular wall made of thermoplastic material and containing therein,
(ii.) an inner tubular wall made of fire resistant material, the inner tubular wall axially parallel with the exterior tubular wall and having ports at regular intervals along its length and around the circumference providing communication of a fire extinguishing fluid there through, the inner tubular wall defining a chamber, and
(iii.) a quantity of the fire extinguishing fluid under pressure in the chamber.

2. The apparatus of claim 1 wherein the inner tubular wall has ports at regular intervals along it length and further limited to ports around one-quarter to one-half of its circumference.

4. The apparatus of claim 1 including a pressure-tight fluid line providing fluid communication between the chamber and a fire extinguishing fluid reservoir.

5. The apparatus of claim 1 including a pressure-tight fluid line providing fluid communication between the chamber and a fire extinguishing fluid reservoir external to the exterior tubular wall.

6. The apparatus of claim 1 wherein the inner tubular wall is coaxial with the outer tubular wall.

7. The apparatus of claim 1 wherein the fire extinguishing fluid is an aqueous fluid.

8. The apparatus of claim 1 wherein the fire extinguishing fluid is gaseous.

9. A vehicle fire extinguishing system comprising:
(a.) a reservoir of fire extinguishing gas under pressure;
(b.) a fire extinguisher attached to the vehicle in view of a wheel well, the fire extinguisher comprising an elongated tube having:
(i.) a pressure-tight exterior tubular wall made of thermoplastic material and containing therein,
(ii.) an inner tubular wall made of fire resistant material, the inner tubular wall co-linear with and spaced from the exterior tubular wall and having ports at regular intervals along its length providing communication of a fire extinguishing gas there through, the inner tubular wall defining a chamber, and
(iii.) a first pressure-tight gas line providing fluid communication between the reservoir and the chamber.

10. A vehicle fire extinguishing system comprising:
(a.) a reservoir of fire extinguishing gas under pressure;
(b.) a fire extinguisher attached to the vehicle in view of a wheel well, the fire extinguisher comprising an elongated tube having:
(i.) a pressure-tight exterior tubular wall made of thermoplastic material and containing therein,
(ii.) an inner tubular wall made of fire resistant material, the inner tubular wall axially parallel with the exterior tubular wall and having ports at regular intervals along its length providing communication of a fire extinguishing gas there through, the inner tubular wall defining a chamber, and
(iii.) a first pressure-tight gas line providing fluid communication between the reservoir and the chamber;
(c.) a second pressure-tight gas line providing fluid communication between the reservoir and a vehicle tire containing fire extinguishing gas.

11. The vehicle fire extinguishing system of claim 10, including:
(d.) a double-walled fuel tank, with two pressure-tight walls and an annular space there between, and a third pressure-tight gas line providing fluid communication between the reservoir and the annular space.

12. The vehicle fire extinguishing system of claim 10 additionally comprising:
(e.) a fourth pressure-tight gas line having a length and flexibility sufficient to provide fire extinguishing gas from the reservoir to the exterior of the vehicle.

13. The vehicle fire extinguishing system of claim 10 additionally comprising a shut-off valve in the second pressure-tight gas line.

14. The vehicle fire extinguishing system of claim 10 additionally comprising a shut-off valve in the third pressure-tight gas line.

15. The vehicle fire extinguishing system of claim 10 additionally comprising a fuel analyzer in the third pressure-tight gas line.

16. The vehicle fire extinguishing system of claim 10 additionally comprising a fuel analyzer and shut-off valve in the third pressure-tight gas line.

17. The vehicle fire extinguishing system of claim 10 wherein the fire extinguishing gas is carbon dioxide.

18. The vehicle fire extinguishing system of claim 10 wherein the fire extinguishing gas is vehicle exhaust gas.

19. The vehicle fire extinguishing system of claim 10 wherein the inner tubular wall has ports at regular intervals along it length and further limited to ports around one-quarter to one-half of its circumference.

20. The vehicle fire extinguishing system of claim 10 wherein the inner tubular wall has ports at regular intervals both along it length and around one quarter to one half of its circumference and wherein the fire extinguisher is positioned in the wheel well such that the circumferential ports direct gas flow in a downward direction.
